(19) United States
(12) Patent Application Publication
(10) Pub. No.: US 2019/0156260 A1
(43) Pub. Date: May 23, 2019

(54) Method of Data Update and Data System Using the Same

(71) Applicants: Inventec (Pudong) Technology Corp., Shanghai (CN); Inventec Corporation, Taipei (TW)

(72) Inventors: Yu-Zhen Huang, Taipei (TW); Chun-Kang Wang, Taipei (TW); Hsiao-Fan Chu, Taipei (TW); Chih-Cheng Chen, Taipei (TW); Jia-Hao Chen, Taipei (TW); Min-Hsiang Yang, Taipei (TW)

(21) Appl. No.: 15/860,678

(22) Filed: Jan. 3, 2018

(30) Foreign Application Priority Data
Nov. 17, 2017 (CN) 201711141789.2

(51) Int. Cl. G06Q 10/06; G06F 17/30; G06Q 10/08

(52) U.S. Cl. CPC G06Q 10/06315; G06Q 10/0875; G06F 17/30345

(57) ABSTRACT

A method of data update, for determining a material qualification status of at least one supplier according to a plurality of smelters of a material used by the at least one supplier, the method comprising obtaining a qualified smelter list of the material from a predetermined website; and comparing the qualified smelter list of the material with a material list of the at least one supplier corresponding to the material to determine the material qualification status of the at least one supplier, so as to perform a violation warning operation; wherein the material list of each supplier of the material list of the at least one supplier denotes the plurality of smelters of the material used by the at least one supplier in system codes; wherein the qualified smelter list denotes a plurality of qualified smelters of the material in international codes.

### BACKGROUND OF THE INVENTION

### 1. Field of the Invention

The present invention relates to a method of data update and a data system, and more particularly, to a method of data update and a data system capable of automatically updating a qualified smelter list to perform comparison so as to determine material qualification statuses of suppliers in a supply chain.

### 2. Description of the Prior Art

In general, the electronic manufactory uses different materials for manufacturing electronic devices, and the materials used by the manufactory may be produced by different smelters. More specifically, the materials may come from the place where the labor environment is poor or the country is in war. The international community supervises the sources of certain materials (i.e. conflict minerals) from the perspectives of the social justice, the environmental protection and the global climate changing. In detail, the international community prohibits the conflict minerals produced by the specific smelters to avoid indirectly exploiting labors or financially funding the war countries and expect the electronic manufactories to take the social responsibility by properly choosing the sources of the materials. Among all the organizations, the Electronic Industry Citizenship Coalition composed by the major manufactories has the most rigorous and complete regulations, i.e. the Electronic Industry Code of Conduct (EICC), wherein the EICC regulates the conflict minerals and the qualified smelters of each material. The electronic manufactories desired to sale their products on the market must strictly follow the regulations of the list of qualified smelters published by the EICC; otherwise, products not following the EICC are banned by the Electronic Industry Citizenship Coalition.

Furthermore, for the numerous kinds in the conflict materials and the smelter list of each material, the data size of smelters of the materials used by the suppliers in the supply chain of each manufactory of the electronic is huge. It usually takes a lot of time and human efforts for the electronic manufactory to compare the qualified smelter list with the smelter list of the material used in the supply chain such that the sources of the material for producing the products by the manufactory may conform to the regulations of the EICC. However, performing the comparison operation manually is inefficient and may not eliminate the human errors during the comparison operation. In addition, it may cause the electronic manufactory to use the unqualified materials when producing the product, such that the product manufactured by the electronic manufactory is prohibited by the Electronic Industry Citizenship Coalition.

Therefore, how to determine whether the materials used by the electronic manufactory are qualified according to the qualified smelter list of the conflict minerals is a significant objective in the field.

### SUMMARY OF THE INVENTION

It is therefore a primary objective of the present invention to provide a method of data update and a data system capable of determining that whether the material used by the electronic manufactory is qualified according to the qualified smelter list of the conflict minerals so as to improve over disadvantages of the prior art.

The present invention discloses a method of data update, for determining a material qualification status of at least one supplier according to a plurality of smelters of a material used by the at least one supplier, the method comprising obtaining a qualified smelter list of the material from a predetermined website; and comparing the qualified smelter list of the material with a material list of the at least one supplier corresponding to the material to determine the material qualification status of the at least one supplier, so as to perform a violation warning operation; wherein the material list of each supplier of the material list of the at least one supplier denotes the plurality of smelters of the material used by the at least one supplier in system codes; wherein the qualified smelter list denotes a plurality of qualified smelters of the material in international codes.

The present invention further discloses a data system, for determining a material qualification status of at least one supplier according to a plurality of smelters of a material used by the at least one supplier, comprising an acquisition module, for obtaining a qualified smelter list of the material from a predetermined website; a determination module, coupled to the acquisition module, for comparing the qualified smelter list of the material with a material list of the at least one supplier to determine the material qualification status of the at least one supplier, so as to perform a violation warning operation; and a storage unit, coupled to the acquisition module and the determination module, for storing the original qualified smelter list; wherein the material list of each supplier of the material list of the at least one supplier denotes the plurality of smelters of the material used by the at least one supplier in system codes; wherein the qualified smelter list denotes a plurality of qualified smelters of the material in international codes.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a data system according to an embodiment of the present invention.

FIG. 2 is a schematic diagram of a data update process according to an embodiment of the present invention.

### DETAILED DESCRIPTION

In general, during the manufacturing process of the electronic industry, the Electronic Industry Code of Conduct (EICC) proposed by the major electronic companies is the most important inspection regulation to the manufacturing chain in the electronic industry in the world. More specifically, the EICC strictly restricts the sources of the conflict minerals used by the electronic manufactory. In other words, the EICC strictly restricts the smelter sources of the conflict minerals used by the electronic manufactory. The qualified smelter list of the conflict minerals published by the EICC has become the most important criterion for the electronic manufactory to obey when choosing the smelters of the material used in the manufacturing process. Under such a circumstance, to further improve the efficiency and the accuracy of the comparison operation which the electronic manufactory compares qualified smelter list with the smelters of the material used by each supplier in the supply chain, the present invention provides a data system capable of automatically updating the qualified smelter list and comparing the qualified smelter list with the smelters of the material used by each supplier in the supply chain so as to determine the material qualification status of each supplier. Therefore, the electronic manufactory may efficiently and correctly manage the sources of the materials and the material qualification status of each supplier in the supply chain.

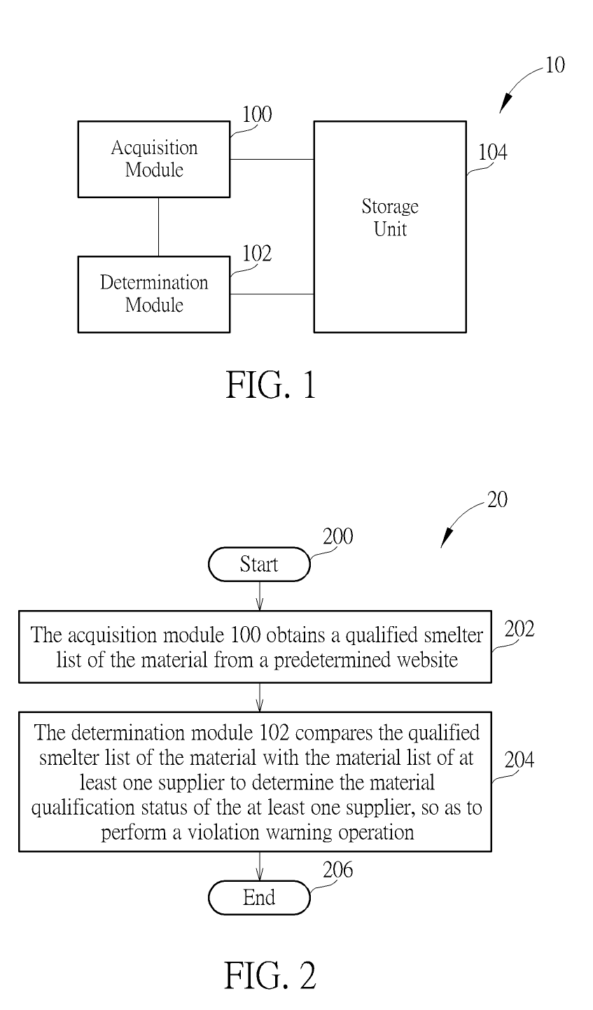

Please refer to FIG. 1, which is a schematic diagram of a data system 10 according to an embodiment of the present invention. The data system 10 is utilized for managing the sources of the material used by the suppliers in the supply chain of the electronic manufactory to determine whether the material qualification statuses of the suppliers in the supply chain meet the regulations of the EICC. In detail, the data system 10 is connected to the internet and capable of receiving data of the EICC through the internet so as to automatically update and obtain the qualified smelter list published by the EICC. In addition, the data system 10 stores a source list of the suppliers to record the smelter list of the material used by each supplier in the supply chain of the electronic manufactory. Therefore, the data system 10 is able to compare the qualified smelter list with the source list of the suppliers so as to determine the material qualification statuses of the suppliers in the supply chain and accordingly operate a violation warning operation.

The data system 10 comprises an acquisition module 100, a determination module 102 and a storage unit 104. The acquisition module 100 is utilized for obtaining the qualified smelter list of the conflict minerals published by the EICC from a predetermined website. The determination module 102 is coupled to the acquisition module 100, and utilized for comparing the qualified smelter list with the material list of the suppliers to determine the material qualification statuses of the suppliers, and accordingly perform the violation warning operation. The storage unit 104 is coupled to the acquisition module 100 and the determination module 102, and utilized for storing the previous qualified smelter list and the material list of the suppliers, wherein the previous qualified smelter list is the qualified smelter list before updated by the acquisition module 100, and the material list of the suppliers is the smelter list of the material used by the suppliers in the supply chain and recorded by the manufactory of the electronics.

In other words, the data system 10 of the present invention may manage the sources of the materials of each supplier in the supply chain of the electronic manufactory, determine the material qualification statuses of the suppliers in the supply chain, and accordingly perform the violation warning operation so as to meet the regulations of EICC.

The operation of the data system 10 may be summarized as a data update process 20, as shown in FIG. 2. The data update process 20 comprises the following steps:

Step 200: Start.

Step 202: The acquisition module 100 obtains a qualified smelter list of the material from a predetermined website.

Step 204: The determination module 102 compares the qualified smelter list of the material with the material list of at least one supplier to determine the material qualification status of the at least one supplier, so as to perform a violation warning operation.

Step 206: End.

Therefore, the electronic manufactory is able to utilize the data system 10 according to an embodiment of the present invention and manage the smelters of the material used by the suppliers in the supply chain according to the data update process 20. In detail, in Step 202, the acquisition module 100 of the data system 10 connects to the predetermined website to obtain the qualified smelter list. For example, the acquisition module 100 may connect to the EICC website to access the qualified smelter list published by the EICC. In Step 204, the determination module 102 obtains the qualified smelter list from the acquisition module 100 and obtains the material list of the suppliers from the storage unit 104 for comparing the qualified smelter list with the material list of the suppliers to determine the material qualification status of each supplier in the supply chain.

Furthermore, in an embodiment, the determination module 102 obtains the qualified smelter list and obtains the previous qualified smelter list stored by the storage unit 104. The determination module 102 compares the qualified smelter list with the previous qualified smelter list to generate a list of qualified changes and a list of unqualified changes, wherein the previous qualified smelter list is the qualified smelter list before updated by the acquisition module 100 and stored by the data system 10. The determination module 102 compares the qualified smelter list with the previous qualified smelter list so as to determine the updated information of the qualified smelter list, wherein the determination module 102 stores the smelters as the list of qualified changes which the smelters are added in the qualified smelter list but not stored in the previous qualified smelter list, and the determination module 102 stores the smelters as the list of unqualified changes which the smelters are deleted from the qualified smelter list but stored in the previous qualified smelter list in the list. Under such a circumstance, according to the list of qualified changes and the list of unqualified changes, the data system 10 determines the updated detail of the qualified smelter list to accordingly compare the list of unqualified changes with the material list of the suppliers so as to further determine the material qualification statuses of the suppliers and perform the violation warning operation.

Notably, in the embodiment, the qualified smelter list comprises multiple materials and the qualified smelters of each material, wherein each smelter is denoted by corresponding international code in the qualified smelter list; the material list of the suppliers comprises multiple suppliers and the smelters of each material used by each supplier, wherein each smelter is denoted by corresponding system code in the material list of the suppliers. Similarly, each smelter is denoted by corresponding international code in the list of qualified changes and the list of unqualified changes. Therefore, before comparing the list of unqualified changes with the material list of the suppliers to determine the material qualification statuses of the suppliers, the determination module 102 converts each smelter in the list of unqualified changes from the international code to the system code according to a lookup table stored by the storage unit 104. Under such a circumstance, the determination module 102 may utilize the list of unqualified changes and the material list of the suppliers for comparison so as to determine the material qualification statuses of the suppliers. For example, the determination module 102 sequentially compares the corresponding system code of each smelter of each supplier in the material list of the suppliers with the corresponding system code of each smelter in the list of unqualified changes according to the order of the suppliers in the material list of the suppliers so as to determine whether each smelter of the material used by each supplier in the material list of the suppliers is a certified smelter. In addition, the determination module 102 accordingly generates a material list of unqualified suppliers so as to determine the material qualification status of each supplier. In detail, when the comparison result between the system code of the smelter of the material used by the supplier in the material list of the suppliers and the system code of the smelter in the list of unqualified changes matches, the determination module 102 determines that the material qualification status of the supplier is an unqualified status; when the comparison result between the comparison result between the system code of the smelter of the material used by the supplier in the material list of the suppliers and the system code of the smelter in the list of unqualified changes does not match, the determination module 102 determines that the material qualification status of the supplier is a qualified status. After the determination module 102 determines the material qualification statuses of the suppliers, the determination module 102 records the material qualification status of each supplier so as to generate the material list of unqualified suppliers. Furthermore, the determination module 102 records the corresponding system codes of the smelters when the comparison result between the list of unqualified changes and the material list of the suppliers matches. Therefore, the material list of unqualified suppliers generated by the determination module 102 comprises the unqualified suppliers, the unqualified material, and the system codes of the smelters. Under such a circumstance, the electronic manufactory may search the material list of unqualified suppliers to determine whether the material qualification status of the supplier in the manufactory's supply chain is the qualified status. Furthermore, when the material qualification status of the supplier is the unqualified status, the electronic manufactory may obtain the information of what material of the supplier is unqualified and what system code of the smelter of the unqualified smelter is according to the material list of unqualified suppliers. At last, the determination module 102 performs the violation warning operation according to the material qualification statuses of the suppliers. Notably, the violation warning operation performed by the data system 10 is not limited herein. In other words, the violation warning operation may be an automatically generated e-mail, a voice message, a document file or an alert window generated in the operating system performed by the other electronic equipment according to different requirements of the data system, the electronic manufactory or the suppliers, as long as the unqualified suppliers may be informed through the warning operations, which are within the scope of the present invention.

In brief, the data system 10 of the present invention automatically updates the qualified smelter list and compares the qualified smelter list with the smelter list of the material used by the supplier in the supply chain of the electronic manufactory according to the data update process 20 so as to determine whether the material qualification status of each supplier in the supply chain is the qualified status. In addition, the data system 10 also generates the material list of unqualified suppliers according to the comparison result so as to record the unqualified suppliers and the smelters of the material of the unqualified suppliers. Therefore, the data system 10 is able to determine the material qualification status of each supplier according to the material list of unqualified suppliers and further search the smelters of the material used by the unqualified suppliers, such that the electronic manufactory completely satisfies the material regulations of the EICC.

Notably, the embodiments stated in the above are utilized for illustrating the concept of the present invention. Those skilled in the art may make modifications and alterations accordingly, and not limited herein. For example, in Step 204, when the data system 10 compares the qualified smelter list with the material list of the suppliers, the data system 10 may not compare the qualified smelter list with the previous qualified smelter list first. Alternatively, the data system 10 may look up the lookup table first to convert each international code of each smelter of the material in the qualified smelter list into the system code. The data system 10 utilizes the qualified smelter list and the source list of the suppliers to compare and determine the material qualification statuses of the suppliers.

In another embodiment, the supplier in the supply chain of the electronic manufactory may obtain the material from other suppliers. Therefore, the architecture of the source list of the suppliers may be multi-level. In other words, the suppliers in the source list of the suppliers comprise the smelters of the material and additionally comprise the downstream suppliers. The downstream suppliers further comprise the smelters of the material. Under such a circumstance, in Step 204, when the determination module 102 determines the material qualification statuses of the suppliers, the material list of unqualified suppliers generated by the determination module further comprises the downstream suppliers of the unqualified suppliers and the smelters of the material used by the downstream suppliers so as to determine the material qualification statuses of the suppliers.

In another embodiment, in Step 204, when the determination module 102 generates the material list of unqualified suppliers so as to determine the material qualification statuses of the suppliers, the determine module 102 may further generate a material list of qualified suppliers which is a list of qualified suppliers, such that the material list of qualified suppliers may be provided to the electronic manufactory when the electronic manufactory is selecting the suppliers of the material.

Therefore, the electronic manufactory automatically updates the qualified smelter list and accurately determines the material qualification status of each supplier in the supply chain without updating the material qualification statuses manually according to the data system 10 and the data update process 20 of the present invention. Under such a circumstance, the present invention saves the comparison time and substantially increases the comparison accuracy according to the data system and the data update process, such that the materials used by the electronic manufactory completely conform to the regulations of the conflict minerals published by the EICC.

In the prior art, the electronic manufactory may only compare the smelters of the material used by the suppliers in the supply chain with the qualified smelter list manually, which is inefficient and may not avoid the human errors. Compared to the prior art, the present invention provides the comparison which is more efficient to the electronic manufactory according to the data update process and the data system. The method of data update and the data system of the present invention substantially decreases the comparison time and the comparison errors to further record the comparison result, such that the material sources of the unqualified suppliers in the supply chain is effectively tracked and managed.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of data update, for determining a material qualification status of at least one supplier according to a plurality of smelters of a material used by the at least one supplier, the method comprising:
obtaining a qualified smelter list of the material from a predetermined website; and
comparing the qualified smelter list of the material with a material list of the at least one supplier corresponding to the material to determine the material qualification status of the at least one supplier, so as to perform a violation warning operation;
wherein the material list of each supplier of the material list of the at least one supplier denotes the plurality of smelters of the material used by the at least one supplier in system codes;
wherein the qualified smelter list denotes a plurality of qualified smelters of the material in international codes.

2. The method of claim 1, wherein the step of comparing the qualified smelter list of the material with the material list of the at least one supplier corresponding to the material to determine the material qualification status of the at least one supplier, so as to perform the violation warning operation comprises:
comparing the qualified smelter list with an original qualified smelter list to generate a list of qualified changes and a list of unqualified changes;
looking up a lookup table according to the list of the unqualified change to convert the plurality international codes of the list of the unqualified change to the plurality system codes; and
comparing the plurality system codes of the list of the unqualified change with the material list of the at least one supplier, and generating a material list of unqualified suppliers so as to determine the material qualification status of the at least one supplier.

3. The method of claim 2, further comprising:
sequentially comparing the material list of the at least one supplier with the plurality of system codes of the list of unqualified changes;
when the system codes of the plurality of smelters of the material list of the at least one supplier matches the plurality of system codes of the list of unqualified changes, determining that the material qualification status of the supplier is an unqualified status; or
when the system codes of the plurality of smelters of the material list of the at least one supplier does not match the plurality system codes of the list of the unqualified change, determining that the material qualification status of the supplier is a qualified status.

4. The method of claim 3, further comprising:
recording the supplier having the material qualification status of the unqualified status according to the material qualification status of the at least one supplier, and recording the system code of the unqualified smelter of the material used by the supplier having the material qualification status of the unqualified status, so as to generate a material list of unqualified suppliers.

5. The method of claim 3, further comprising:
recording the supplier having the material qualification status of the qualified status according to the material qualification status of the at least one supplier, and recording the system code of the qualified smelter of the material used by the supplier having the material qualification status of the qualified status, so as to generate a material list of qualified suppliers.

6. A data system, for determining a material qualification status of at least one supplier according to a plurality of smelters of a material used by the at least one supplier, comprising:
an acquisition module, for obtaining a qualified smelter list of the material from a predetermined website;
a determination module, coupled to the acquisition module, for comparing the qualified smelter list of the material with a material list of the at least one supplier to determine the material qualification status of the at least one supplier, so as to perform a violation warning operation; and
a storage unit, coupled to the acquisition module and the determination module, for storing the original qualified smelter list;
wherein the material list of each supplier of the material list of the at least one supplier denotes the plurality of smelters of the material used by the at least one supplier in system codes;
wherein the qualified smelter list denotes a plurality of qualified smelters of the material in international codes.

7. The data system of claim 6, wherein the determination module is further configured to perform the following steps, for comparing the qualified smelter list of the material with the material list of the at least one supplier corresponding to the material to determine the material qualification status of the at least one supplier:
comparing the qualified smelter list with the original qualified smelter list to generate a list of qualified changes and a list of unqualified changes;
looking up a lookup table according to the list of the unqualified change to convert the plurality international codes of the list of the unqualified change to the plurality system codes; and
comparing the plurality system codes of the list of the unqualified change with the material list of the at least one supplier, and generating a material list of unqualified suppliers so as to determine the material qualification status of the at least one supplier,
wherein the lookup table is stored in the storage unit.

8. The data system of claim 7, wherein the determination module is further configured to perform the following steps:
sequentially comparing the material list of the at least one supplier with the plurality of system codes of the list of unqualified changes;
when the system codes of the plurality of smelters of the material list of the at least one supplier matches the plurality system codes of the list of unqualified changes, determining that the material qualification status of the supplier is an unqualified status; or
when the system codes of the plurality of smelters of the material list of the at least one supplier does not match the plurality system codes of the list of the unqualified change, determining that the material qualification status of the supplier is a qualified status.

9. The data system of claim 8, wherein the determination module is further configured to perform the following step:
recording the supplier having the material qualification status of the unqualified status according to the material qualification status of the at least one supplier, and recording the system code of the unqualified smelter of the material used by the supplier having the material qualification status of the unqualified status, so as to generate a material list of unqualified suppliers.

10. The data system of claim 8, wherein the determination module is further configured to perform the following step:
recording the supplier having the material qualification status of the qualified status according to the material qualification status of the at least one supplier, and recording the system code of the qualified smelter of the material used by the supplier having the material qualification status of the qualified status, so as to generate a material list of qualified suppliers.
